(19) United States
(12) Patent Application Publication
(10) Pub. No.: US 2005/0199634 A1
(43) Pub. Date: Sep. 15, 2005

(54) Structure and method of insert mold

(75) Inventors: Shinichiro Choji, Tokyo (JP); Hiroki Isobe, Kanagawa-ken (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD., Kanagawa-ken (JP)

(21) Appl. No.: 11/124,267

(22) Filed: May 9, 2005

Related U.S. Application Data
(63) Continuation of application No. 09/996,572, filed on Nov. 30, 2001, now abandoned.

(30) Foreign Application Priority Data
Dec. 22, 2000 (JP) P2000-390727

(51) Int. Cl. B65B 3/00; B67C 3/00

(52) U.S. Cl. 220/562

(57) ABSTRACT

In a first part made of a thermoplastic resin, a second part coated with the same resin is insert-molded. The applied resin of the second part and the resin of the first part melt together by heating during molding to thereby obtain firm bonding.

### BACKGROUND OF THE INVENTION

1. Field of the Invention

The present invention relates to an insert mold structure obtained by combining different parts with each other during insert mold and also the method thereof.

2. Description of the Related Art

Fuel tank bodies which are used in vehicles such as cars are often made of a resin and mounted with an upper plate made of a resin and the like for attaching a pump module on the upper side thereof in general. The upper plate is secured to the tank body by a metal cam lock member which is insert-molded in the fuel tank.

It is known that when a fuel tank body is made of a resin, a filler tube made of polyacetal or nylon is connected through a flange made of the same material that is used for the fuel tank. This filler tube is molded in advance, then insert mold in a part made of the same resin that is used for the fuel tank body made of a resin and the part is heat welded on the fuel tank.

As other materials of this type, those described in the publication of Japanese Patent Application Laid-Open (JP-A) No. 10-000314 are known.

### SUMMARY OF THE INVENTION

When the upper plate is constituted of a material different from that of the fuel tank, an adhesive is often used to mount the fuel tank with the upper plate. However, there is a possibility that the component of the adhesive adversely affects either the upper plate or the fuel tank or the both materials. The joint portion tends to have insufficient bonding strength, particularly when it is deteriorated with time and there is therefore the possibility of giving rise to the problem of the leakage of fuel. When a part is directly welded on the plastic tank, there is the possibility of unsatisfactory bonding strength if the part and the tank are made of different materials.

It is an object of the present invention to provide an insert mold structure having high bonding strength.

An insert mold structure according to the present invention comprises inserting a first part coated with a paint made of a thermoplastic material in a second part constituted of the same material.

### BRIEF DESCRIPTION OF THE DRAWINGS

FIG. 1 is a sectional view showing an insert mold structure and an insert mold method in the first embodiment according to the present invention.

FIG. 2 is a perspective view showing an insert mold structure and an insert mold method in the first embodiment according to the present invention. The section along the line 1-1 in the FIG. 2 is shown in FIG. 1.

FIG. 3 is a perspective view of a cam lock member in the first embodiment according to the present invention. The section along the line 4-4 in the FIG. 3 is shown in FIG. 4.

FIG. 4 is a sectional view of a cam lock member in the first embodiment according to the present invention.

FIG. 5 is a perspective view of a filler tube in the second embodiment according to the present invention. The section along the line 6-6 in the FIG. 5 is shown in FIG. 6.

FIG. 6 is a sectional view of a filler tube in the second embodiment according to the present invention.

FIG. 7 is a sectional view showing an insert mold structure and an insert mold method in the second embodiment according to the present invention. A filler tube is connected to a flange member welded on a fuel tank.

FIG. 8 shows an insert mold structure and insert mold method in the first modified example of the second embodiment according to the present invention.

FIG. 9 shows an insert mold structure and insert mold method in the second modified example of the second embodiment according to the present invention.

### DETAILED DESCRIPTION OF THE PREFERRED EMBODIMENT

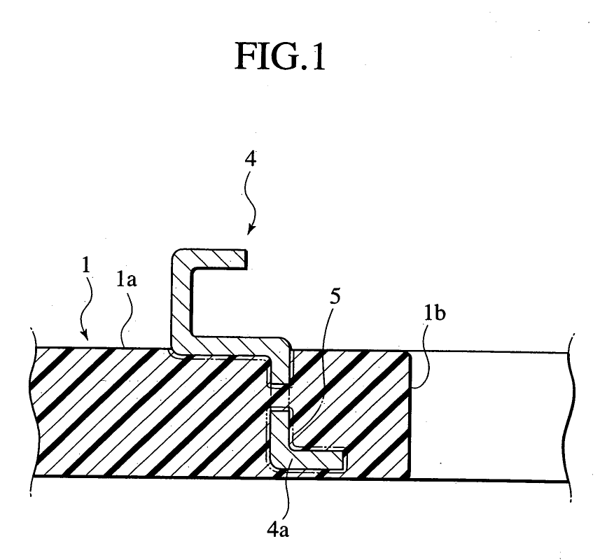

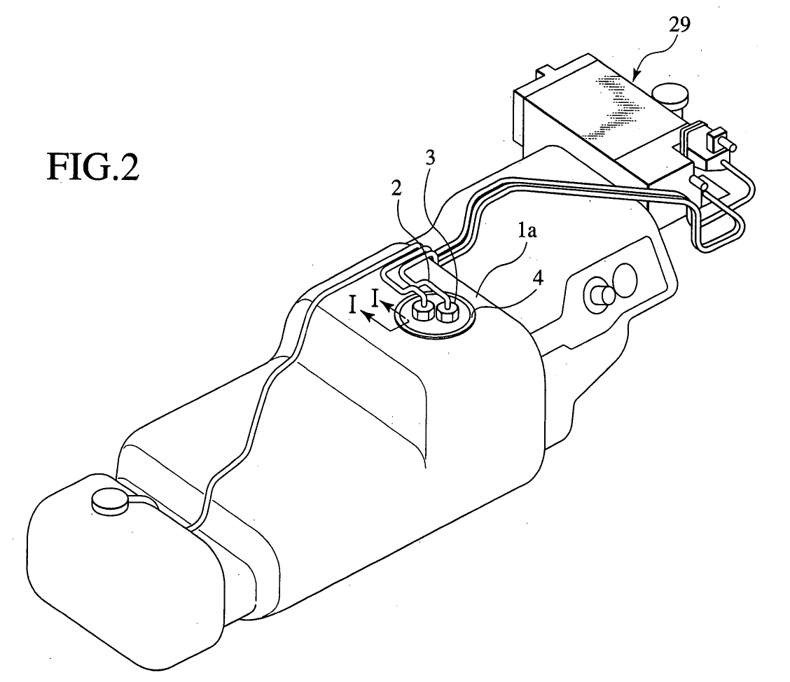

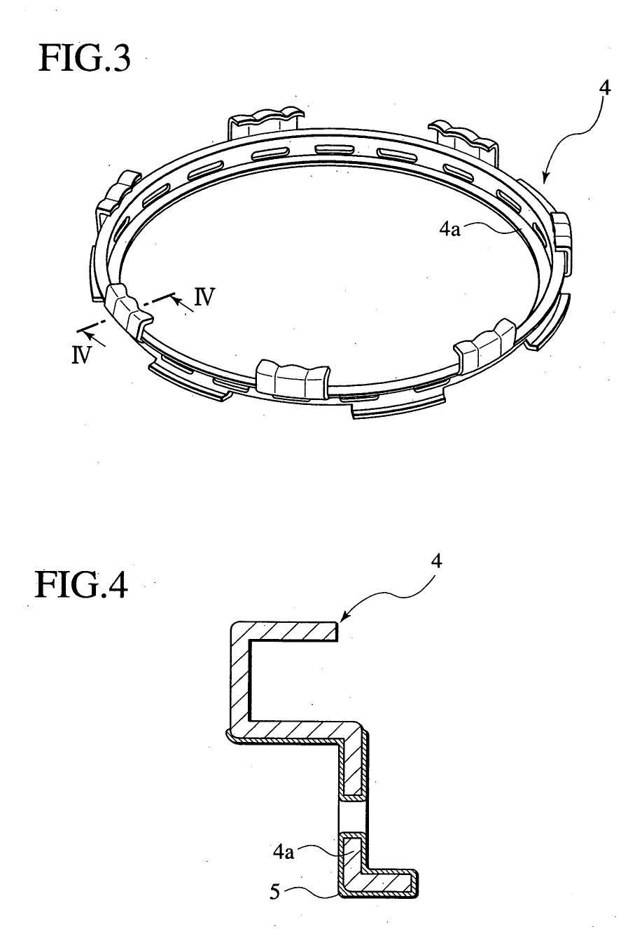

FIG. 1 to FIG. 4 show an insert mold structure and insert mold method in the first embodiment according to the present invention. A metallic upper plate 3 for attaching a pump module 2 is mounted on the upper portion of a plastic tank body 1a which is a first part constituting a fuel tank 1.

This tank body 1a is produced by blow-molding high density polyethylene (HDPE: having a large molecular weight, being chemically stable and being characterized by high impact strength. MFR (Melt Flow Rate, showing flowability)=about 3 to 7 g/min) as raw material and a metal cam lock member 4 to which the upper plate 3 is to be secured is insert-molded in the upper surface portion of the tank.

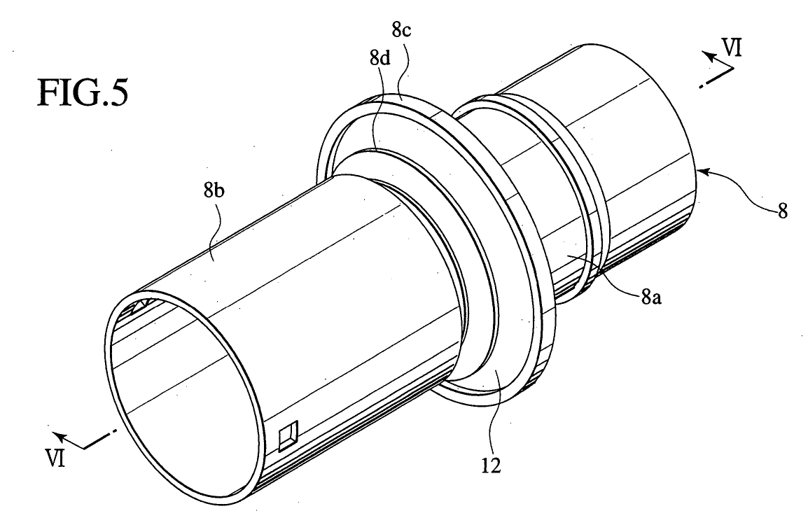

This cam lock member 4 is provided with powder coating prior to insert mold and has a coating layer 5 surrounding a foot portion 4a embedded in the wall of the tank body 1a as shown in FIG. 4.

A polyethylene which is the same material that is used for the fuel tank 1 is used as the base of the resin used for the powder coating. The molecular weight of the base resin and the qualities and ratios of additives are regulated to obtain high flowability (MFR=about 15 g/min) so that the resin is uniformly spread on the surface of the foot portion 4a when it is heat-treated during coating.

In this first embodiment, the resin is heat-treated in the condition of 150 to 210° C. and 20 to 40 minutes, more preferably 180° C. and 30 minutes, in the coating operation. By this heat treatment, the coating powder is uniformly spread on the surface of the foot portion 4a and stuck firmly to the surface. In order to make the adhesion of the powder stronger, the foot portion 4a can be processed in advance by proper surface treatment, for example, chemical conversion treatment.

Then, this foot portion 4a is embedded in the periphery of a plate opening portion 1b which is formed with an opening in the tank body 1a. The tank body and the applied polyethylene are softened and melt together by heat treatment with molding and strong bonding is thus achieved.

A firmly adhesive layer is formed between the powder coating and the foot portion 4a by the heat treatment. Because the powder coating and the tank body melt together while the adhesive layer remains, bonding strength between the foot portion and the tank body is stronger than that obtained when the foot portion 4a is directly insert-molded in the tank body.

The powder coating of the cam lock member 4 is effective as an anti-rusting layer, which makes it possible to omit rust preventive treatment such as a zinc plating and a chromate treatment. Moreover, the powder coating enables easy handling, which can simplify the process steps and suppress a rise in production cost.

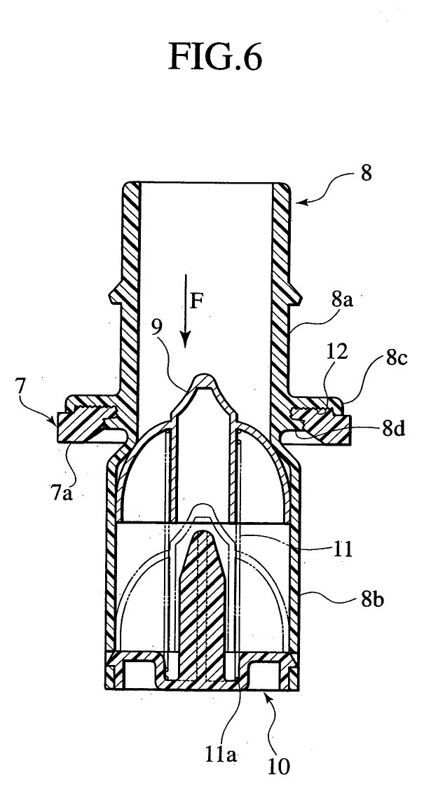

FIG. 5 to FIG. 8 show an insert mold structure and an insert mold method in the second embodiment according to the present invention. Parts which are the same as or equivalent to those of the first embodiment are represented by the same numerals.

In this second embodiment, a weld flange member 7 as the first part is made of polyethylene and a filler tube 8 as the second part is made of polyacetal or nylon; in short, the both are made of a resin.

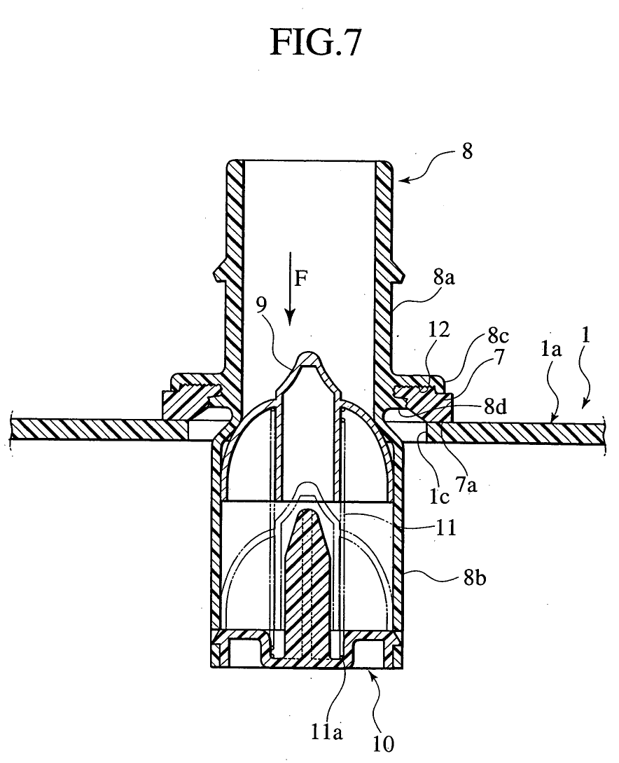

The weld flange member 7 is formed ring-wise and has a joint face 7a to be bonded to the periphery of a tube opening portion 1c formed in a tank 1a of a fuel tank 1 by heat weld as shown in FIG. 7. The filler tube 8 is connected to the fuel tank 1 through this flange member 7.

The filler tube 8 primarily comprises a small diameter portion 8a and a large diameter portion 8b. A jagged portion 8c is integrated with and projected from the peripheral surface in the vicinity of the boundary between the small diameter portion 8a and the large diameter portion 8b. A small jagged portion 8d is integrated with and projected from the outer periphery in the inside of the jagged portion 8c to prevent the filler tube 8 from falling out.

A coating layer 12 made of a powder resin is formed on the surfaces of these jagged portion 8c and falling-preventive jagged portion 8d by powder coating.

In this second embodiment, the melting point of the powder coating made of polyethylene is designed to be lower than the melting point of the filler tube 8 made of polyacetal or nylon.

Further, a sliding member 9 is disposed in the large diameter portion 8b and is pressed towards the direction of the small diameter portion 8a by a spring 11 one end 11a of which is brought into contact with a lid 10 which almost seals an opening portion formed at the edge.

In this second embodiment, even if the weld flange member 7 and the filler tube 8 are constituted of different types of resin, firm bonding can be obtained since the coating layer 12 and the flange member 7 melt together during inserting. For example, even if the filler tube 8 is made of polyacetal or nylon which is reduced in the permeation of fuel such as gasoline and the weld flange member 7 is made of polyethylene having high capability of bonding with the fuel tank 1, the both can be bound firmly.

For this, as shown in FIG. 7, the joint face 7a may be bonded directly with the periphery of the tube opening portion 1c formed in the tank body 1a of the fuel tank 1 by using an adhesive.

In such a manner as described above, the filler tube 8 made of polyacetal or nylon which originally involves a difficulty in binding with the fuel tank 1 can be firmly bound.

Further, in this second embodiment, the falling-preventive small jagged portion 8d is integrated with and projected from the outer peripheral surface and further, the flange member 7 is firmly bound. As a result, the filler tube 8 can be connected firmly.

Moreover, in this second embodiment, since the melting point of the powder paint made of polyethylene is lower than the melting point of the filler tube 8 made of a polyacetal resin or nylon, there is no fear that the filler tube is adversely affected at the temperature condition under which the powder paint and the weld flange member 7 melt together in the insert mold step, and high shape stability is obtained.

Other structures, actions and effects are the same as or equivalent to those of the above-described first embodiment.

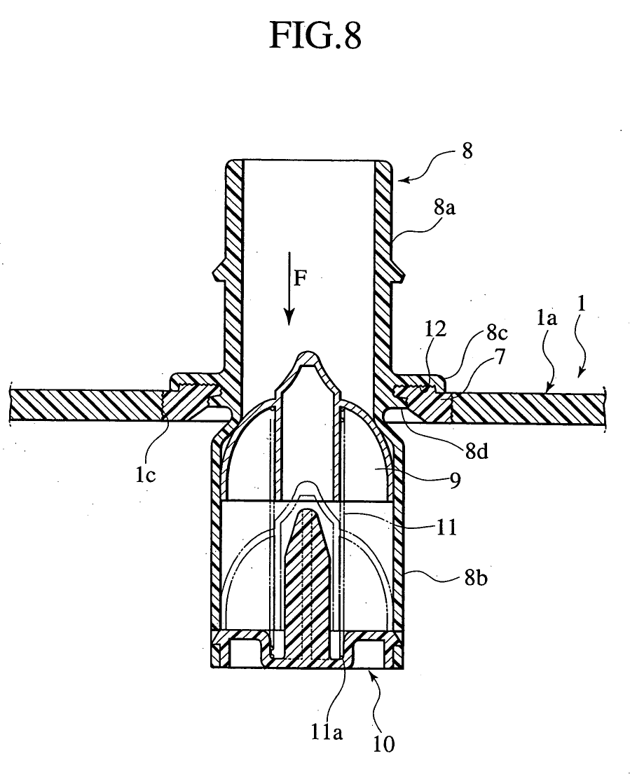

FIG. 8 shows an insert mold structure and an insert mold method in the first modification of the second embodiment according to the present invention. Parts which are the same as or equivalent to those of the first embodiment are represented by the same numerals.

In this first modification, the weld flange member 7 is insert-molded in the inner periphery of the tube opening portion 1c of the fuel tank 1 made of high density polyethylene.

In such a structure, the weld flange member 7 is firmly bound with the filler tube 8 and insert-molded in the fuel tank 1. Therefore, even if the filler tube 8 is made of polyacetal or nylon which involves a difficulty in directly bonding with the fuel tank 1, it can be connected firmly.

Other structures, actions and effects are the same as or equivalent to those of the above-described first embodiment and second embodiment.

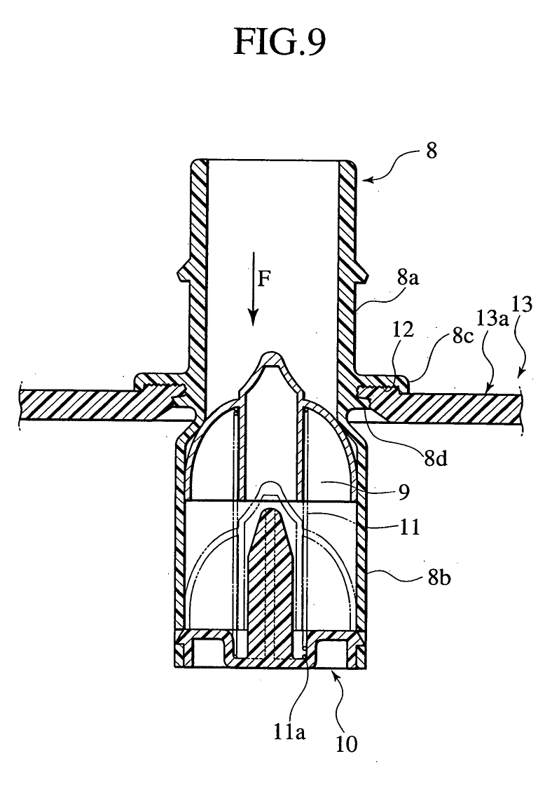

FIG. 9 shows an insert mold structure and an insert mold method in a modification 2 of the embodiment 2 according to the present invention. Parts which are the same as or equivalent to those of the embodiments 1 and 2 and modification 1 are represented by the same symbols.

In this second modification, a filler tube 8 made of polyacetal or nylon as the second part is insert-molded directly in a tube opening portion 13c of a fuel tank 13 made of high density polyethylene as the first part.

In the second modification constituted in the above-described manner, the tube opening portion 13c is firmly bound by the powder coating layer 12 formed on the surfaces of the jagged portion 8c and falling-preventive small jagged portion 8d of the filler tube 8. Therefore, the filler tube 8 made of, for example, polyacetal or nylon which is reduced in the permeation of gasoline can be bonded directly with the fuel tank 13 made of high density polyethylene.

Other structures, actions and effects are the same as or equivalent to those of the above-described first embodiment and second embodiment and first modification.

The contents of Japanese Patent Application No. 2000-390727 (filed Dec. 22, 2000) are incorporated herein by reference.

Although the invention has been described above by reference to certain embodiments of the invention, the invention is not limited to the embodiments described above. Modifications and variations of the embodiments described above will occur to those skilled in the art, in light of the above teachings.

1-19. (canceled)

20. An insert mold structure comprising:
a first part made of polyethylene;
a second part made of a material selected from the group of metals and resins, each of the resins having a lower permeation characteristic for gasoline than polyethylene, coated with a coating made of polyethylene, the second part being insert-molded in the first part; and
an adhesive layer between the first part and the second part, the adhesive layer being formed from the coating while the second part is insert molded in the first part.

21. An insert mold structure according to claim 20, wherein the coating is powder coating.

22. An insert mold structure according to claim 20, wherein the coated second part is heat-treated.

23. An insert mold structure according to claim 20, wherein the melting point of the coating is lower than the melting point of the second part.

24. An insert mold structure comprising:
a first part consisting essentially of polyethylene;
a second part consisting essentially of a material selected from the group of metals and resins, each of the resins having a lower permeation characteristic for gasoline than polyethylene, coated with a coating, the coating including polyethylene, the first part and the second part being insert-molded; and
an adhesive layer between the first part and the second part, the adhesive layer being formed from the coating while the first part and the second part are insert-molded.

25. An insert mold structure according to claim 24, wherein the second part and the coating are heat-treated.

26. An insert mold structure according to claim 24, wherein the melting point of the coating is lower than the melting point of the second part.
